(19) United States
(12) Patent Application Publication
(10) Pub. No.: US 2022/0207374 A1
(43) Pub. Date: Jun. 30, 2022

(54) MIXED-GRANULARITY-BASED JOINT SPARSE METHOD FOR NEURAL NETWORK

(71) Applicant: ZHEJIANG UNIVERSITY, Zhejiang (CN)

(72) Inventors: Cheng ZHUO, ZHEJIANG (CN); Chuliang GUO, ZHEJIANG (CN); Xunzhao YIN, ZHEJIANG (CN)

(73) Assignee: ZHEJIANG UNIVERSITY, ZHEJIANG (CN)

(21) Appl. No.: 17/517,662

(22) Filed: Nov. 2, 2021

(30) Foreign Application Priority Data
Dec. 24, 2020 (CN) 202011553635.6

(51) Int. Cl. G06N 3/08; G06N 3/04

(52) U.S. Cl. CPC G06N 3/082; G06N 3/04

(57) ABSTRACT

Disclosed in the present invention is a mixed-granularity-based joint sparse method for a neural network. The joint sparse method comprises independent vector-wise fine-grained sparsity and block-wise coarse-grained sparsity; and a final pruning mask is obtained by performing a bitwise logic AND operation on pruning masks independently generated by two sparse methods, and then a weight matrix of the neural network after sparsity is obtained. The joint sparsity of the present invention always obtains the reasoning speed between a block sparsity mode and a balanced sparsity mode without considering the vector row size of the vector-wise fine-grained sparsity and the vector block size of the block-wise coarse-grained sparsity. Pruning for a convolutional layer and a fully-connected layer of a neural network has the advantages of variable sparse granularity, acceleration of general hardware reasoning and high accuracy of model reasoning.

### CROSS-REFERENCE TO RELATED APPLICATION

This application claims the priority benefit of China application serial no. 202011553635.6, filed on Dec. 24, 2020. The entirety of the above-mentioned patent application is hereby incorporated by reference herein and made a part of this specification.

### FIELD OF TECHNOLOGY

The present invention relates to the technical fields of engineering, such as structured sparse and light-weight network structure and convolutional neural network, and in particular to a mixed-granularity-based joint sparse method for a neural network.

### BACKGROUND

In recent years, deep learning, especially a convolutional neural network (CNN), has achieved great success with high accuracy in the fields of computer vision, voice recognition and language processing. Due to the growth in data volume, deep neural networks become larger and larger in scale to have universal feature extraction capabilities. On the other hand, with over-parameterization of deep neural networks, large models often require significant computational and storage resources in the training and reasoning process. Faced with these challenges, people are paying more and more attention to techniques such as tensor decomposition, data quantization and network sparsity for compressing and accelerating neural networks at a minimize computational cost.

In sparsity, for different pruned data objects, the sparse mode thereof can be divided into fine-grained and coarse-grained sparse modes, and the purpose thereof is to eliminate unimportant elements or connections. Fine-grained sparse mode is more likely to retain higher model accuracy. However, due to computational complexity, it is difficult in practice to directly measure the importance of weight elements in a neural network. Therefore, a fine-grained weight pruning method is generally based on amplitude standards, but this often results in random remodeling of the weight structure, which is poorly supported by general purpose accelerators (such as GPU). In other words, the randomness and irregularity of the weight structure after pruning results in that the fine-grained sparse mode can only save the memory space, and can hardly accelerate reasoning on the GPU.

Different from the fine-grained sparse mode, the coarse-grained sparse mode is considered as a beneficial alternative to improve the hardware implementation efficiency. The coarse-grained sparse mode is usually pruned in units of a specific region rather than a single element. It may incorporate neural network semantics (such as kernel, filter, and channel) into the CNNs and retain a compact substructure after pruning. Recently, it has been observed that structural sparse training is helpful for GPU acceleration. However, related research often involves a regular constraint item, such as requiring expensive division and square root operations of L 1 and L2 norms. Such an approach also automatically generates different sparsity ratios in each layer, making the final achieved sparsity level uncontrollable.

In order to give priority to ensuring a sufficient sparsity level, researchers propose another type of structured sparsity mode, that is, the network is pruned iteratively by relying on a target sparsity threshold specified or calculated by a user. For example, block sparse mode and balanced sparse mode. However, the block sparse mode having acceptable model accuracy is generally only capable of generating a weight structure having relatively low sparsity.

Therefore, in order to obtain high model accuracy and fast hardware execution speed, it is always desirable to achieve a balance between structural uniformity and sparsity. Intuitive observation is to employ a more balanced workloads and a more fine-grained sparse mode. Therefore, the present invention proposes a mixed-granularity-based joint sparse method for a neural network, which is the key to achieve efficient GPU reasoning in a convolutional neural network.

### SUMMARY

The purpose of the present invention is to provide a mixed-granularity-based joint sparse method for a neural network, aiming at the shortcomings of the current structured sparse method in the prior art. The joint sparse method is applied to the pruning of a convolutional layer and a fully-connected layer of a neural network, and has the advantages of variable granularity of sparse modes, acceleration of general hardware reasoning, and high accuracy of model reasoning.

The objective of the present invention is achieved by means of the following technical solutions: a mixed-granularity-based joint sparse method for a neural network, wherein the method is used for image recognition, and the method comprises: firstly, acquiring several pieces of image data and artificially labeling the image data, so as to generate an image data set; inputting the image data set as a training set into a convolutional neural network; randomly initializing a weight matrice of various layers of the convolutional neural network; and performing training in an iterative manner and adopting a joint sparse process, so as to prune the convolutional neural network;

wherein the joint sparse process is specifically a process of obtaining pruning masks having different pruning granularities by presetting a target sparsity and a mixing ratio of granularity by a user, the joint sparse process comprises independent vector-wise fine-grained sparsity and block-wise coarse-grained sparsity; wherein according to the target sparsity and the mixing ratio of granularity preset by the user, respective sparsities of the vector-wise fine-grained sparsity and the block-wise coarse-grained sparsity are estimated and obtained by a sparsity compensation method;

in the vector-wise fine-grained sparsity, a weight matrix with the number of rows being #row and the number of columns being #col is filled with zero columns at an edge of the matrix, so that the number of columns of a zero-added minimum matrix is exactly divided by K, and the zero-added minimum matrix is divided into several vector rows with the number of rows being 1 and the number of columns being K; for each vector row, amplitude-based pruning is performed on an element in the vector row, and on a pruning mask I, 1 of a corresponding element position is set as 0, so that the number of 0 on the pruning mask I meets the requirements of the vector-wise fine-grained sparsity;

in the block-wise coarse-grained sparsity, a weight matrix with a row number being #row and a column number being #col is filled with zero rows and/or zero columns at an edge of the matrix, so that a zero-added minimum matrix is exactly divided by blocks with sizes of R rows and S columns, and is divided into several vector blocks with the number of rows being R and the number of columns being S; an importance psum of each vector block not containing zero-filled rows or zero columns are calculated; amplitude-based pruning is performed on all vector blocks participating in the calculation of the importance psum according to the importance psum and size; and 1 of the corresponding element position of the vector block participating in the calculation of the importance psum on a pruning mask II is set to 0, so that the number of 0 on the pruning mask II meets the requirements of sparsity of the block-wise coarse-grained sparsity;

performing a bitwise logical operation on the pruning mask I obtained by sparsifying the vetor-wise fine-grained sparsity and the pruning mask II obtained by sparsifying the block-wise coarse-grained sparsity, so as to obtain a final pruning mask III; and performing a bitwise logical AND operation on the final pruning mask III and a matrix with the number of rows being #row and the number of columns being #col, so as to obtain a weight matrix after sparsity; and

after a weighting matrix of each layer of a convolutional neural network is sparse and the training is completed, inputting an image to be recognized into the convolutional neural network for image recognition.

Further, the vector-wise fine-grained sparsity is performing amplitude-based pruning according to an absolute value of an element in a vector row.

Further, the importance psum of the vector block is the sum of squares of each element within the vector block.

Further, elements in matrix of the pruning mask I and the pruning mask II of vector-wise fine-grained sparsity and block-wise coarse-grained sparsity are initially 1.

Further, amplitude-based pruning of vector-wise fine-grained sparsity and block-wise coarse-grained sparsity is performed on the pruning mask I and the pruning mask II, and an element at a corresponding position in a vector raw or a vector block that is less than a threshold of sparsity is set to 0.

Further, according to the target sparsity and the mixing ratio of granularity preset by a user, the process of estimating and obtaining respective sparsity of the vector-wise fine-grained sparsity and the block-wise coarse-grained sparseness by a sparsity compensation method is as follows:

s_{f}=sₜ× [symbol] /max(1− [symbol] , [symbol] )

s_{c}=sₜ×(1− [symbol] )/max(1− [symbol] , [symbol] )

wherein and sₜ, s_{f} and s_{c} are respectively target sparsity preset by a user, vector-wise fine-grained sparsity and block-wise coarse-grained sparsity, p is a mixing ratio of granularity, and is a number between 0 and 1.

The beneficial effects of the present invention are as follows:

1. Proposed is a mixed-granularity-based joint sparse method for a neural network. The method does not need a regular constraint item, and can realize hybrid sparse granularity, thereby reducing reasoning overheads and ensuring the accuracy of a model.

2. Proposed is a sparse compensation method for optimizing and ensuring a reached sparse rate. At the same target sparsity, the achieved sparsity may be adjusted by the proposed hyper-parameter so as to trade off between model accuracy and sparsity ratio.

3. The joint sparsity always obtains the reasoning speed between a block sparsity mode and a balanced sparsity mode without considering the vector row size of the vector-wise fine-grained sparsity and the vector block size of the block-wise coarse-grained sparsity.

### BRIEF DESCRIPTION OF THE DRAWINGS

FIG. 1(a) is a pruning mask of a vector-wise fine-grained sparsity;

FIG. 1(b) is a pruning mask of a joint sparse method;

FIG. 1(c) is a pruning mask of a block-wise coarse-grained sparsity;

FIG. 2 is an embodiment of a vector-wise fine-grained sparsity; and

FIG. 3 shows actual sparsity that can be achieved by using a sparsity compensation method.

### DESCRIPTION OF THE EMBODIMENTS

Detailed Description The present invention is hereinafter described in detail with reference to the accompanying drawings and embodiments.

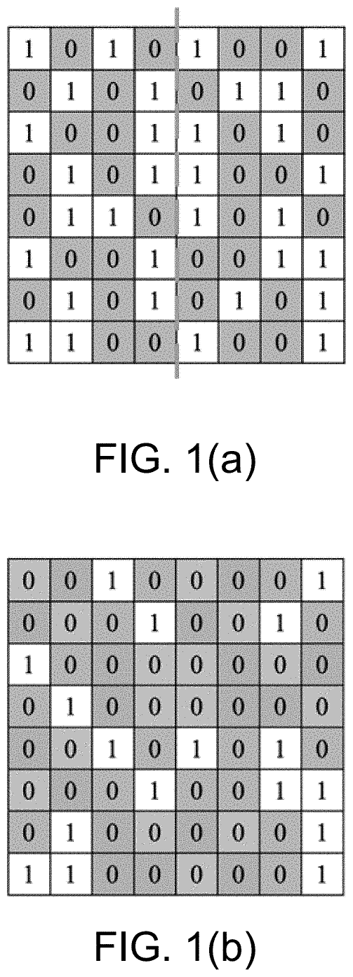

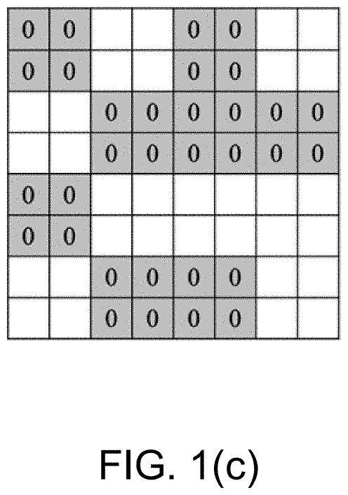

As shown in FIG. 1(a), FIG. 1(b) and FIG. 1(c), the present invention provides a mixed-granularity-based joint sparse method for a neural network. The method is used for image recognition, such as automatic marking of machine-readable card test papers. The method comprises: firstly, acquiring several pieces of image data and artificially labeling the image data, so as to generate an image data set and divide the image data set into a training data set and a test data set; inputting the training data set into a convolutional neural network; randomly initializing a weight matrice of various layers of the convolutional neural network; and performing training in an iterative manner and adopting a joint sparse process, so as to prune the convolutional neural network; cross verifying the training effect by means of the test data set, and updating the weight matrix of each layer by means of a back propagation algorithm until the training is completed, at this time, the neural network can judge the correct and wrong questions for the input machine-readable card test paper by comparing with the correct answers; wherein the joint sparse process is specifically a process of obtaining pruning masks having different pruning granularities by presetting a target sparsity and a mixing ratio of granularity by a user, and the joint sparse process comprises independent vector-wise fine-grained sparsity and block-wise coarse-grained sparsity; wherein according to the target sparsity and the mixing ratio of granularity preset by the user, respective sparsities of the vector-wise fine-grained sparsity and the block-wise coarse-grained sparsity are estimated and obtained by a sparsity compensation method, comprising the following implementation steps:

(1) Vector-wise fine-grained sparsity: in the vector-wise fine-grained sparsity, a weight matrix with the number of rows being #row and the number of columns being #col is filled with zero columns at an edge of the matrix, so that the number of columns of a zero-added minimum matrix is exactly divided by K, and the zero-added minimum matrix is divided into several vector rows with the number of rows being 1 and the number of columns being K; for each vector row, amplitude-based pruning is performed on an element in the vector row, and on a pruning mask I, 1 of a corresponding element position is set as 0, so that the number of 0 on the pruning mask I meets the requirements of the vector-wise fine-grained sparsity.

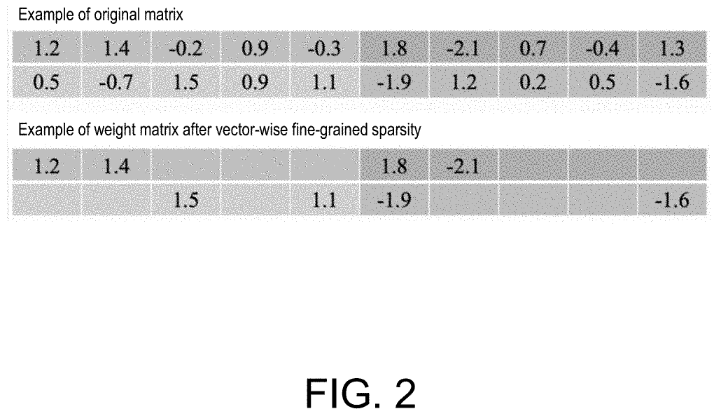

The vector-wise fine-grained sparsity is crucial to the model accuracy of the joint sparse method because it has the advantage of fine-grained, and almost no constraint is imposed on the sparse structure. In addition, different from the unstructured sparsity of sequencing and pruning in the whole network, the vector-wise fine-grained sparsity is more direct and effective for sequencing and pruning weights in a specific region (for example, vectors within a row) of the network. FIG. 2 illustrates an example of vector-wise fine-grained sparsity in rows of the weight matrix. Each row in the weight matrix is divided into several vector rows with the same size with the number of rows being 1 and the number of columns being K, and the weight with the minimum absolute value will be pruned according to the sparse threshold value of the current iteration round. Therefore, the pruned weight can achieve the same sparsity at the vector-wise and channel-wise.

In addition to being efficiently implemented in a specific region of a network, maintaining model accuracy and simplifying the sequencing complexity of weight elements, the vector-wise fine-grained sparsity has the advantages of having a balanced workload, and being applicable to shared memory between parallel GPU threads. For various GPU platforms, the parameter K can be specified as the maximum capacity in the shared memory.

(2) Block-wise coarse-grained sparsity: in the block-wise coarse-grained sparsity, a weight matrix with a row number being #row and a column number being #col is filled with zero rows and/or zero columns at an edge of the matrix, so that a zero-added minimum matrix is exactly divided by blocks with sizes of R rows and S columns, and is divided into several vector blocks with the number of rows being R and the number of columns being S; an importance psum of each vector block not containing zero-filled rows or zero columns are calculated; amplitude-based pruning is performed on all vector blocks participating in the calculation of the importance psum according to the importance psum and size; and 1 of the corresponding element position of the vector block participating in the calculation of the importance psum on a pruning mask II is set to 0, so that the number of 0 on the pruning mask II meets the requirements of sparsity of the block-wise coarse-grained sparsity.

Compared with fine-grained pruning, coarse-grained pruning usually performs better in shaping a more hardware-friendly substructure, but at the cost of reduced model accuracy. The purpose of block-wise coarse-grained sparsity is to provide a suitable matrix substructure for the computational parallelism of the GPU. The existing commodity GPU (for example, a Volta, Turing, and Nvidia A100 GPU) deployed in an application scenario of deep learning generally uses dedicated hardware called a Tensor Core. The hardware has advantages in terms of fast matrix multiplication and supports a new data type. This brings benefits to the deep neural networks where the basic arithmetic computation is a large number of standard matrix multiplications in the convolutional layer and a fully-connected layer of a neural network, and its multiplication computation speed, rather than memory, limits performance.

One solution is to adapt the size of the partitioned blocks to the size of the GPU tile and the number of the Streaming Multiprocessors (SMs). Ideally, the matrix size can be exactly divided by the block size, and the number of GPU tiles created can be exactly divided by the number of SMs. Given a particular neural network model, the number of SMs can often be exactly divided, so the present invention focuses on the block size applicable to the GPU tile. By selecting the size of the block having the same coarse-grained sparsity as the size of the GPU tile, the GPU tile can be fully occupied. Furthermore, as addition takes much less time and area overhead than multiplication, and weight gradients are readily available in back propagation, the present invention applies first order Taylor approximation and as a criterion for pruning vector blocks.

(3) Mixed-granularity-based joint sparse method: the overall idea of implementing the mixed-granularity-based joint sparse method is performing a bitwise logical AND operation on the fine-grained sparse pruning mask I and the coarse-grained sparse pruning mask II which are independently generated, so as to form a final pruning mask III. performing a bitwise logical AND operation on the final pruning mask III and a matrix with the number of rows being #row and the number of columns being #col, so as to obtain a weight matrix after sparsity.

In the present invention, elements in matrix independently generated of the pruning mask I and the pruning mask II of vector-wise fine-grained sparsity and block-wise coarse-grained sparsity are initially 1. On the pruning mask I and the pruning mask II, and an element at a corresponding position in a vector raw or a vector block that is less than a threshold of sparsity is set to 0, instead of sequentially applying vector-wise fine-grained sparsity and block-wise coarse-grained sparsity to the pruning mask. Because some channels may be more important than other channels, in these more valuable channels, a large number of important weights are pruned in sequential pruning, thereby potentially causing a decrease in model accuracy.

After a weighting matrix of each layer of a convolutional neural network is sparse and training is completed, image data of the machine-readable card test paper which need to be reviewed is acquired, an image to be recognized is input into the convolutional neural network for image recognition, and a score of each machine-readable card test paper is output.

In order to obtain the mixed sparse granularity of the joint sparse method, an artificially set hyperparameter is set in the present invention, and represented as a granularity mixing ratio p, so as to control the sparsity ratio of a target sparsity contribution of vector-wise fine-grained sparsity. For example, if the target sparsity of the convolutional layer is 0.7 (i.e. the ratio of zeros in the weight matrix of the pruned convolutional layer reaches 70%), and the mixing ratio p of the granularity is 0.8, then the sparsities contributed by the fine-grained sparsity and the block-wise coarse sparsity should be 0.56 and 0.14, respectively. By examining the sparsity actually achieved in the convolutional layer, we find that sparsity is lower than target sparsity because the fine-grained sparse pruning mask I and coarse-grained sparse pruning mask II overlap on some weight elements. This may explain that certain weights are valued in both pruning standards. Therefore, the present invention proposes a sparsity compensation method, and reapproximations the respective sparsities of the vector-wise fine-grained sparsity and the block-wise coarse-grained sparsity:

s_{f}=sₜ× [symbol] /max(1− [symbol] , [symbol] )

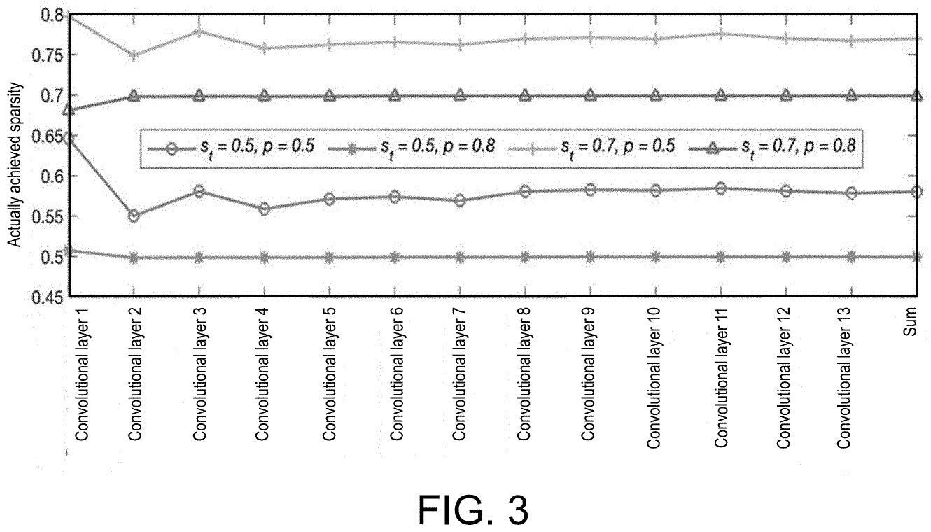

s_{c}=sₜ×(1− [symbol] )/max(1− [symbol] , [symbol] )

wherein sₜ, s_{f} and s_{c} are respectively target sparsity preset by a user, vector-wise fine-grained sparsity and block-wise coarse-grained sparsity, p is a mixing ratio of granularity, and is a number between 0 and 1. This sparsity compensation method can be seen from another perspective: for a mixture ratio p greater than 0.5, vector-wise fine-grained sparsity that reapproximates the target sparsity can be considered as a major contributor to the target sparsity, and coarse-grained sparsity at the block wise can further yield more zeros according to another weight pruning standard. Vice versa for cases where p is less than 0.5. As shown in FIG. 3, when the sparsity compensation method is adopted, the predetermined target sparsity can be fully achieved regardless of the value thereof. In addition, when p is close to 0 or 1, a more obvious main pruning scheme appears having sparsity closer to the target sparsity than it is. Alternatively, when p is about 0.5, the surplus sparsity can be weighted between achievable sparsity and model accuracy by adjusting the time of initial dense training.

In generating a fine-grained sparse pruning mask I and a coarse-grained sparse pruning mask II, the present invention cuts the weight matrix iteratively, and retrains the network several times after each pruning. Pruning and then training is defined as one iteration. In practice, iterative pruning can generally prune more weight elements and maintain the accuracy of the model. The present invention computes the current sparsity threshold by using an exponential function with a positive but decreasing first derivative:

$${s}_{fthres} = {s}_{f} - {s}_{f} \times {( 1 - \frac{{e}_{c} - {e}_{i}}{{e}_{total}} )}^{r}$$

$${s}_{cthres} = {s}_{c} - {s}_{c} \times {( 1 - \frac{{e}_{c} - {e}_{i}}{{e}_{total}} )}^{r}$$

wherein, s_{fthres} and sₒₜₕᵣₑₛ are vetor-wise fine-grained sparsity threshold and a block-wise coarse-grained sparsity threshold for a current epoch. eᵢ is the initial epoch of pruning, as early dense training is crucial to maintain the accuracy of the model. The r control threshold increases exponentially fast and slow. In the present invention, pruning and training processes are iterated in the whole training process to achieve a target sparsity, then a fine-grained sparse pruning mask I and a coarse-grained sparse pruning mask II are generated, and a final pruning mask III is formed by performing a bitwise logic AND operation. In particular, the balanced sparse mode may be implemented by p=1, and the block sparse mode and the sparse mode of the channel-wise structure may be implemented by p=0.

The present patent is not limited to the preferred embodiments described above. With the motivation of the present patent, anyone can obtain other various forms of a mixed-granularity-based joint sparse mode and implementation method thereof, and any equivalent variation and modification made according to the scope of the present invention patent application shall belong to the scope of the present patent.

What is claimed is:

1. A mixed-granularity-based joint sparse method for a neural network, wherein the method is used for image recognition, and the method comprises: firstly, acquiring several pieces of image data and artificially labeling the image data, so as to generate an image data set; inputting the image data set as a training set into a convolutional neural network; randomly initializing a weight matrice of various layers of the convolutional neural network; and performing training in an iterative manner and adopting a joint sparse process, so as to prune the convolutional neural network;
wherein the joint sparse process is specifically a process of obtaining pruning masks having different pruning granularities by presetting a target sparsity and a mixing ratio of granularity by a user, and the joint sparse process comprises independent vector-wise fine-grained sparsity and block-wise coarse-grained sparsity; wherein according to the target sparsity and the mixing ratio of granularity preset by the user, respective sparsities of the vector-wise fine-grained sparsity and the block-wise coarse-grained sparsity are estimated and obtained by a sparsity compensation method;
in the vector-wise fine-grained sparsity, a weight matrix with a number of rows being #row and a number of columns being #col is filled with zero columns at an edge of the matrix, so that a number of columns of a zero-added minimum matrix is exactly divided by K, and the zero-added minimum matrix is divided into several vector rows with the number of rows being 1 and the number of columns being K; for each vector row, amplitude-based pruning is performed on an element in the vector row, and on a pruning mask I, 1 of a corresponding element position is set as 0, so that the number of 0 on the pruning mask I meets the requirements of the vector-wise fine-grained sparsity;
in the block-wise coarse-grained sparsity, a matrix with the number of rows being #row and the number of columns being #col is filled with zero rows and/or zero columns at the edge of the matrix, so that the zero-added minimum matrix is exactly divided by blocks with sizes of R rows and S columns, and is divided into several vector blocks with the number of rows being R and the number of columns being S; an importance psum of each vector block not containing zero-filled rows or zero columns are calculated; amplitude-based pruning is performed on all vector blocks participating in the calculation of the importance psum according to the importance psum and size; and 1 of the corresponding element position of the vector block participating in the calculation of the importance psum on a pruning mask II is set to 0, so that the number of 0 on the pruning mask II meets the requirements of sparsity of the block-wise coarse-grained sparsity;
performing a bitwise logical operation on the pruning mask I obtained by sparsifying the vector-wise fine-grained sparsity and the pruning mask II obtained by sparsifying the block-wise coarse-grained sparsity, so as to obtain a final pruning mask III; and performing a bitwise logical AND operation on the final pruning mask III and a matrix with the number of rows being #row and the number of columns being #col, so as to obtain a weight matrix after sparsity; and
after a weighting matrix of each layer of a convolutional neural network is sparse and the training is completed, inputting an image to be recognized into the convolutional neural network for image recognition.

2. The mixed-granularity-based joint sparse method for a neural network according to claim 1, wherein the vector-wise fine-grained sparsity is performing amplitude-based pruning according to an absolute value of the element in the vector row.

3. The mixed-granularity-based joint sparse method for a neural network according to claim 1, wherein the importance psum of the vector block is the sum of squares of each element within the vector block.

4. The mixed-granularity-based joint sparse method for a neural network according to claim 1, wherein elements in matrix of the pruning mask I and the pruning mask II of vector-wise fine-grained sparsity and block-wise coarse-grained sparsity are initially 1.

5. The mixed-granularity-based joint sparse method for a neural network according to claim 1, wherein amplitude-based pruning of vector-wise fine-grained sparsity and block-wise coarse-grained sparsity is performed on the pruning mask I and the pruning mask II, and an element at a corresponding position in a vector raw or a vector block that is less than a threshold of sparsity is set to 0.

6. The mixed-granularity-based joint sparse method for a neural network according to claim 1, wherein according to the target sparsity and the mixing ratio of granularity preset by a user, the process of estimating and obtaining respective sparsities of the vector-wise fine-grained sparsity and the block-wise coarse-grained sparsity by a sparsity compensation method is as follows:
s_{f}=sₜ× [symbol] /max(1− [symbol] , [symbol] )
s_{c}=sₜ×(1− [symbol] )/max(1−z,22 , [symbol] )
wherein sₜ, s_{f} and s_{c} are respectively target sparsity preset by a user, vector-wise fine-grained sparsity and block-wise coarse-grained sparsity, p is a mixing ratio of granularity, and is a number between 0 and 1.
